(19) United States
(12) Patent Application Publication
(10) Pub. No.: US 2006/0127642 A1
(43) Pub. Date: Jun. 15, 2006

(54) White, sealable, thermoformable biaxially oriented and coextruded polyester film with cycloolefin copolymer, process for its production, and its use

(76) Inventors: Herbert Peiffer, Mainz (DE); Holger Kliesch, Mainz (DE); Gottfried Hilkert, Saulheim (DE); Cynthia Bennett, Alzey (DE)

Correspondence Address: PROPAT, L.L.C., 425-C SOUTH SHARON AMITY ROAD, CHARLOTTE, NC, 28211-2841, US

(21) Appl. No.: 11/343,707

(22) Filed: Jan. 31, 2006

Related U.S. Application Data
(63) Continuation of application No. 10/311,732, filed on Dec. 18, 2002.

(30) Foreign Application Priority Data
Jun. 20, 2000 (DE) 100 30 235.1

(51) Int. Cl. B32B 27/36; B32B 27/32; B29C 47/06; B29C 55/12

(52) U.S. Cl. 428/141; 428/480; 428/482; 428/336; 428/349; 428/220; 264/173.15; 264/173.16; 264/235.8; 264/920

(57) ABSTRACT

The invention relates to a white, sealable, thermoformable, biaxially oriented and coextruded polyester film that comprises at least one base layer B and at least one sealable cover layer A, wherein at least the base layer B contains a polyester starting compound and a cycloolefin copolymer (COC). The polyester starting compound should contain an increased amount of diethylene glycol, polyethylene glycol or isophthtalic acid. The invention further relates to a method for producing the inventive polyester film and to the use thereof for thermoformed articles, especially on high-speed machines.

### CROSSREFERENCE TO RELATED APPLICATIONS

This application is a continuation of co-pending U.S. application Ser. No. 10/311,732 filed Dec. 18, 2002. Co-pending U.S. application Ser. No. 10/311,732 is hereby incorporated by reference in its entirety. This application further claims priority to its parent, German patent application no. 100 30 235.1 filed Jun. 20, 2000, and PCT/EP01/06679 filed Jun. 13, 2001. Both German patent application no. 100 30 235.1, and PCT/EP01/06679 are hereby incorporated by reference herein in their entirety.

### FIELD OF THE INVENTION

The present invention relates to a white, sealable, thermoformable biaxially oriented, coextruded polyester film which encompasses at least one base layer B and at least one sealable outer layer, where at least the base layer B comprises a polyester and a cycloolefin copolymer (COC). The invention further relates to the use of the polyester film and to a process for its production.

### BACKGROUND OF THE INVENTION

White, biaxially oriented polyester films are known from the prior art. These known prior-art films are either easy to produce or have good optical properties or have acceptable processing performance.

DE-A 23 53 347 describes a process for producing a milky polyester film having one or more layers, characterized in that a mixture is prepared from particles of a linear polyester with from 3 to 27% by weight of a homopolymer or copolymer of ethylene or propylene, and the film is extruded and quenched and biaxially oriented through orientation in directions running perpendicularly to one another, and is heat-set. A disadvantage of this process is that regrind which arises during production of the film (substantially a mixture of polyester and ethylene copolymer or propylene copolymer) cannot be reused for production without yellowing the film. This makes the process uneconomic, and the yellow-tinged film produced with regrind could not gain acceptance in the market. In addition, the roughness values of the film are markedly too high, thus giving the film a very matt appearance (very low gloss), and this is undesirable for many applications.

EP-A-0 300 060 describes a single-layer polyester film which comprises, besides polyethylene terephthalate, from 3 to 40% by weight of a crystalline propylene polymer and from 0.001 to 3% by weight of a surface-active substance. The effect of the surface-active substance is to increase the number of vacuoles in the film and at the same time to reduce their size to the desired extent. This gives the film greater opacity and lower density. A residual disadvantage of the film is that regrind which arises during production of the film (substantially a mixture of polyester and propylene homopolymer) cannot be reused without yellowing the film. This makes the process uneconomic, and the yellow-tinged film produced with regrind could not gain acceptance in the market. In addition, the roughness values of the film are markedly too high, giving it a very matt appearance (very low glow), and this is undesirable for many applications.

EP-A-0 360 201 describes a polyester film having at least two layers and comprising a base layer with fine vacuoles, with a density of from 0.4 to 1.3 kg/dm³, and having at least one outer layer whose density is above 1.3 kg/dm³. The vacuoles are the result of addition of from 4 to 30% by weight of a crystalline propylene polymer, followed by biaxial stretching of the film. The additional outer layer improves the ease of production of the film (no streaking on the film surface), and the surface tension is increased and the roughness of the laminated surface can be reduced. A residual disadvantage is that regrind arising during production of the film (substantially a mixture of polyester and propylene homopolymer) cannot be reused without yellowing the film. This makes the process uneconomic, and the yellow-tinged film produced with regrind could not gain acceptance in the market. In addition, the roughness values of the films listed in the examples are again always too high, giving the film a matt appearance (low gloss), and this is undesirable for many applications.

EP-A-0 795 399 describes a polyester film having at least two layers and comprising a base layer with fine vacuoles, the density of which is from 0.4 to 1.3 kg/dm³, and having at least one outer layer, the density of which is greater than 1.3 kg/dm³. The vacuoles are produced by adding from 5 to 45% by weight of a thermoplastic polymer to the polyester in the base layer, followed by biaxial stretching of the film. The thermoplastic polymers used are, inter alia, polypropylene, polyethylene, polymethylpentene, polystyrene, or polycarbonate, and the preferred thermoplastic polymer is polypropylene. As a result of adding the outer layer, the ease of production of the film is improved (no streaking on the film surface), the surface tension is increased, and the roughness of the laminated surface can be matched to prevailing requirements. Further modification of the film in the base layer and/or in the outer layers, using white pigments (generally TiO₂) and/or using optical brighteners permits the properties of the film to be matched to the prevailing requirements of the application. A continuing disadvantage is that cut material produced during production of the film (substantially a mixture of polyester and the additive polymer) cannot then be used as regrind for film production, since otherwise the film produced with regrind undergoes an undefined color change, which is undesirable. However, this makes the process uneconomic, and the discolored film produced with regrind could not gain acceptance in the market. In addition, the roughness values of the films listed in examples are still always too high, giving the film a matt appearance (low gloss), which is undesirable for many applications.

DE-A 195 40 277 describes a single- or multilayer polyester film which comprises a base layer with fine vacuoles, with a density of from 0.6 to 1.3 kg/dm³, and having planar birefringence of from −0.02 to 0.04. The vacuoles are the result of addition of from 3 to 40% by weight of a thermoplastic resin to the polyester in the base, followed by biaxial stretching of the film. The thermoplastic resins used are, inter alia, polypropylene, polyethylene, polymethylpentene, cyclic olefin polymers, polyacrylic resins, polystyrene, or polycarbonate, preferred polymers being polypropylene and polystyrene. By maintaining the stated limits for the birefringence of the film, the film claimed has in particular superior ultimate tensile strength and superior isotropy properties. However, a residual disadvantage is that regrind arising during production of the film cannot be reused without undefined discoloration of the film, and this is undesirable. This makes the process uneconomic, and the colored film produced with regrind could not gain acceptance in the market. In addition, the roughness values of the films listed in the examples are still always too high, giving the film a matt appearance (low gloss), which is undesirable for many applications.

Sealable, biaxially oriented polyester films are also known from the prior art. These films known from the prior art either have good sealing performance or good optical properties, or acceptable processing performance.

GB-A 1 465 973 describes a coextruded, two-layer polyester film in which one layer is composed of isophthalic-acid-containing and terephthalic-acid-containing copolyesters and the other layer is composed of polyethylene terephthalate. The specification gives no useful data concerning the sealing performance of the film. The film cannot be produced in a reliable process due to lack of pigmentation (the film cannot be wound) and it has restricted further-processing capability. In addition, the GB-A makes no mention at all of white films.

EP-A 0 035 835 describes a coextruded, sealable polyester film, the sealable layer of which has admixed particles to improve winding and processing performance, the average particle size exceeding the thickness of the sealable layer. The particulate additives form surface protrusions which inhibit undesired blocking and sticking to rolls or guides. No further information is provided on the incorporation of antiblocking agents with regard to the other, nonsealable layer of the film. The selection of particles whose diameter is greater than the thickness of the sealable layer in the amounts given in the examples impairs the processing performance of the film, however. The specification provides no information on the sealing temperature range of the film. Seal seam strength is measured at 140° C. and found to be in the range from 63 to 120 N/m (from 0.97 to 1.8 N/15 mm of film width). The EP-A does not describe white films.

EP-A-0 432 886 describes a coextruded, multilayer polyester film which has a first surface on which a sealable layer has been arranged, and has a second surface on which an acrylate layer has been arranged. The sealable outer layer here may also be composed of isophthalic-acid-containing and terephthalic-acid-containing copolyesters. The coating on the reverse side gives the film improved processing performance. The patent gives no indication of the sealing range of the film. The seal seam strength is measured at 140° C. For a sealable layer thickness of 11 μm, the seal seam strength given is 761.5 N/m (11.4 N/15 mm). A disadvantage of the reverse-side acrylate coating is that this side is then not sealable with respect to the sealable outer layer. This means that the film has only very restricted use. The specification does not mention white films.

EP-A-0 515 096 describes a coextruded, multilayer, sealable polyester film which comprises a further additive on the sealable layer. The additive may comprise inorganic particles, for example, and is preferably applied in an aqueous layer to the film during its production. Using this method, the film is claimed to retain its good sealing properties and to be easy to process. The reverse side comprises only very few particles, most of which pass into this layer via the recycled material. Again, this patent gives no indication of the sealing temperature range of the film. The seal seam strength is measured at 140° C. and is above 200 N/m (3 N/15 mm). For a sealable layer of 3 μm thickness, the seal seam strength given is 275 N/m (4.125 N/15 mm). However, the specification does not mention white films.

It was an object of the present invention to provide a white, sealable, thermoformable and biaxially oriented polyester film which has very good sealability and which can be produced very cost-effectively. In particular, it is to be ensured that cut material arising directly during the production process can be reused as regrind for film production in an amount in the range from 10 to 70% by weight, based on the total weight of the film, without any significant resultant adverse effect on the physical properties of the film thus produced. In particular, it is intended that no significant yellowing should arise through the addition of regrind.

### SUMMARY OF ADVANTAGEOUS EMBODIMENTS OF THE INVENTION

The invention achieves the object by providing a white, sealable, biaxially oriented, coextruded polyester film with at least one base layer B and one sealable outer layer A, both composed of thermoplastic polyester. The characterizing features of this film consist in the presence, at least in the base layer B, of an amount in the range from 2 to 60% by weight, based on the weight of the base layer B, of an additional cycloolefin polymer (COC) alongside a polyester, where the glass transition temperature T_{g} of the cycloolefin copolymer (COC) is in the range from 70 to 270° C., and the presence of an increased amount of diethylene glycol and/or polyethylene glycol and/or isophthalic acid in the polyester.

### DETAILED DESCRIPTION OF ADVANTAGEOUS EMBODIMENTS OF THE INVENTION

Good stretchability includes the ability of the film during its production to undergo both longitudinal and transverse stretching efficiently and in particular without break-off. Good thermoformability means that the film can be thermoformed on commercially available thermoforming machinery to give complex and large-surface-area moldings, without uneconomic pretreatment.

To achieve good thermoformability it is important that the polyester for the base layer B and for the outer layer A, or for other outer layers, to contain an amount of ≦0.5% by weight, preferably ≦1.0% by weight, particularly preferably ≦1.2% by weight, of diethylene glycol (DEG), and/or an amount of ≦0.5% by weight, preferably ≦1.0% by weight, in particular ≦1.2% by weight, of polyethylene glycol (PEG), and/or an amount in the range from 3 to 10% by weight of isophthalic acid (IPA).

For the purposes of the present invention, a white, biaxially oriented polyester film is a film which has a whiteness of more than 70%, preferably more than 75%, and particularly preferably more than 80%. The opacity of the film of the invention is moreover more than 55%, preferably more than 60%, and particularly preferably more than 65%.

To achieve the desired whiteness of the film of the invention, the proportion of COC in the base layer B has to be greater than 2% by weight, otherwise the whiteness is below 70%. If, on the other hand, the COC content is greater than 60% by weight, the production of the film becomes uneconomic, since the process for stretching the film becomes unreliable.

It is also necessary for the glass transition temperature T_{g} of the COC used to be greater than 70° C. Otherwise (if the glass transition temperature T_{g} is less than 70° C.) the polymer mixture is difficult to process (difficult to extrude), the desired whiteness is lost, and the regrind used gives a film with a tendency toward increased yellowing. If, on the other hand, the glass transition temperature T_{g} of the selected COC is greater than 270° C., it sometimes becomes impossible to obtain adequately homogeneous dispersion of the polymer mixture in the extruder. The result of this would then be a film with non-uniform properties.

In the preferred embodiment of the film of the invention, the glass transition temperature T_{g} of the COCs used is in the range from 90 to 250° C., and in the very particularly preferred embodiment is in the range from 110 to 220° C.

Surprisingly, it has been found that the addition of a COC in the manner described above can produce a white, opaque film.

The whiteness and also the opacity of the film can be precisely adjusted and adapted to the prevailing requirements as a function of the amount and nature of the COC added. When this measure is taken it is substantially possible to omit other commonly used whitening and opacifying additives. An additional and entirely surprising effect was that the regrind does not, like the polymeric additives of the prior art, have any tendency toward yellowing.

None of these advantages described was foreseeable, especially since although COCs appear to be substantially incompatible with polyethylene terephthalate it is known that they can be oriented using stretching ratios and stretching temperatures similar to those for polyethylene terephthalate. In these circumstances the skilled worker would have expected not to be able to produce a white, opaque film under these production conditions.

In the preferred and the particularly preferred embodiments, the film of the invention has high and, respectively, particularly high whiteness, and high and, respectively, particularly high opacity, while the color change in the film as a result of regrind addition remains extremely small, and is therefore highly cost-effective.

The film of the invention is a multilayer film. Multilayer embodiments have at least two layers and always encompass the COC-containing base layer B and at least one sealable outer layer A. In one preferred embodiment, the COC-containing layer forms the base layer B of the film, with at least one sealable outer layer A and, where appropriate, (an) intermediate layer(s) may be present here on one or both sides. In another preferred embodiment, the COC-containing layer forms the base layer B of the film, with at least one sealable outer layer A, and preferably with another outer layer C, and, where appropriate, (an) intermediate layer(s) may be present here on one or both sides. In another possible embodiment, the COC-containing layer also forms an intermediate layer of the multilayer film. Other embodiments with COC-containing intermediate layers have a five-layer structure and, besides the COC-containing base layer B, have COC-containing intermediate layers on both sides. In another embodiment, the COC-containing layer can form not only the base layer B but also an outer layer on one side of the base layer or intermediate layer. For the purposes of the present invention, the base layer B is that layer whose thickness makes up from more than 30 to 99.5%, preferably from 60 to 95%, of the total film thickness. The outer layer(s) is/are the layer(s) which form(s) the outward-facing layer(s) of the film.

The optional further outer layer C may be sealable, like the outer layer A, or, like the base layer B, may also comprise COC, but may also have other characteristic features, e.g. a matt or particularly rough, or particularly smooth, surface. For example, it may also be a high-gloss layer.

It has also been found here that the film has particularly high gloss even if the non-sealable outer layer C has exactly the same structure as the base layer B, or if the base layer B is at the same time (in the case of a two-layer structure) the nonsealable external layer. The gloss of the resultant film is more than 50, preferably more than 70, and particularly preferably more than 90.

The COC-containing base layer B of the film of the invention comprises a polyester, a COC, and also, where appropriate, other additives, each in an effective amount. This layer generally comprises at least 20% by weight, preferably from 40 to 98% by weight, in particular from 70 to 96% by weight, of polyester, based on the weight of the layer.

Suitable polyesters are polyesters made from ethylene glycol and terephthalic acid (polyethylene terephthalate, PET), from ethylene glycol and naphthalene-2,6-dicarboxylic acid (polyethylene 2,6-naphthalate, PEN), from 1,4-bishydroxymethylcyclohexane and terephthalic acid (poly-1,4-cyclohexanedimethylene terephthalate, PCDT), or else made from ethylene glycol, naphthalene-2,6-dicarboxylic acid and biphenyl-4,4′-dicarboxylic acid (polyethylene 2,6-naphthalate bibenzoate, PENBB). Particular preference is given to polyesters composed of at least 80 mol % of ethylene glycol units and terephthalic acid units, or of ethylene glycol units and naphthalene-2,6-dicarboxylic acid units. The remaining monomer units derive from the other aliphatic, cycloaliphatic or aromatic diols and dicarboxylic acids which may also occur in the outer layer A, and/or in the outer layer C of the multilayer ABC film (B=base layer).

Other examples of suitable aliphatic diols are diethylene glycol, triethylene glycol, aliphatic glycols of the formula HO—(CH₂)ₙ—OH, where n is an integer from 3 to 6 (in particular 1,3-propanediol, 1,4-butanediol, 1,5-pentanediol and 1,6-hexanediol) and branched aliphatic glycols having up to 6 carbon atoms. Among the cycloaliphatic diols, mention should be made of cyclohexanediols (in particular 1,4-cyclohexanediol). Examples of other suitable aromatic diols have the formula HO—C₆H₄—X—C₆H₄—OH, where X is —CH₂—, —C(CH₃)₂—, —C(CF₃)₂—, —O—, —S— or —SO₂—. Bisphenols of the formula HO—C₆H₄—C₆H₄—OH are also very suitable.

Other aromatic dicarboxylic acids are preferably benzenedicarboxylic acids, naphthalenedicarboxylic acids (such as naphthalene-1,4- or -1,6-dicarboxylic acid), biphenyl-x,x′-dicarboxylic acids (in particular biphenyl-4,4′-dicarboxylic acid), diphenylacetylene-x,x′-dicarboxylic acids (in particular diphenylacetylene-4,4′-dicarboxylic acid) or stilbene-x,x′-dicarboxylic acids. Among the cycloaliphatic dicarboxylic acids mention should be made of cyclohexanedicarboxylic acids (in particular cyclohexane-1,4-dicarboxylic acid). Among the aliphatic dicarboxylic acids, the C₃-C₁₉ alkanediacids are particularly suitable, and the alkane moiety here may be straight-chain or branched.

One way of preparing the polyesters is the transesterification process. Here, the starting materials are dicarboxylic esters and diols, which are reacted using the customary transesterification catalysts, such as the salts of zinc, of calcium, of lithium, of magnesium or of manganese. The intermediates are then polycondensed in the presence of conventional polycondensation catalysts, such as antimony trioxide or titanium salts. Another equally good preparation method is the direct esterification process in the presence of polycondensation catalysts. This starts directly from the dicarboxylic acids and the diols.

According to the invention, the COC-containing layer(s) comprise(s), based on the weight of the COC-containing layer, an amount of no less than 2.0% by weight, preferably from 4 to 50% by weight, and particularly preferably from 6 to 40% by weight, of a cycloolefin copolymer (COC). For the present invention it is important that the COC is not compatible with the polyethylene terephthalate and does not form a homogeneous mixture with the same.

Cycloolefin polymers are homopolymers or copolymers which contain polymerized cycloolefin units and, where appropriate, acyclic olefins as comonomer. Suitable cycloolefin polymers for the present invention are those which contain from 0.1 to 100% by weight, preferably from 10 to 99% by weight, particularly preferably from 50 to 95% by weight, of polymerized cycloolefin units, based in each case on the total weight of the cycloolefin polymers. Particular preference is given to polymers composed of monomers of the cyclic olefins of the formulae I, II, III, IV, V or VI: 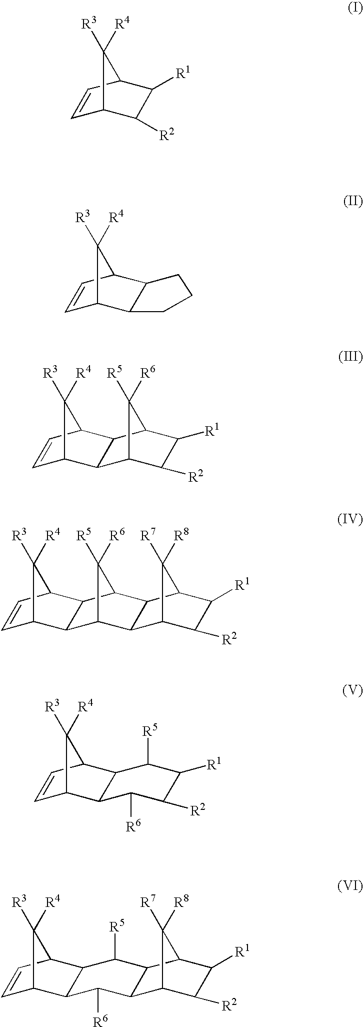
R¹, R², R³, R⁴, R⁵, R⁶, R⁷, and R⁸ in these formulae are identical or different and, independently of one another, are a hydrogen atom or a C₁-C₃₀-hydrocarbon radical; or two or more of the radicals R¹ to R⁸ have cyclic bonding, identical radicals in the various formulae having an identical or different meaning. C₁-C₃₀-Hydrocarbon radicals are preferably linear or branched C₁-C₈-alkyl radicals, C₆-C₁₈-aryl radicals, C₇-C₂₀-alkylenearyl radicals, or cyclic C₃-C₂₀-alkyl radicals, or acyclic C₂-C₂₀-alkenyl radicals.

Where appropriate, the cycloolefin polymers may contain from 0 to 45% by weight, based on the total weight of the cycloolefin polymer, of polymerized units of at least one monocyclic olefin of the formula VII: 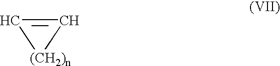
Here, n is a number from 2 to 10.

Where appropriate, the cycloolefin polymers may contain from 0 to 99% by weight, based on the total weight of the cycloolefin polymers, of polymerized units of an acyclic olefin of the formula VIII: 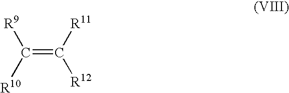
Here, R⁹, R¹⁰, R¹¹, and R¹² are identical or different and, independently of one another, are a hydrogen atom or C₁-C₁₀-hydrocarbon radical, preferably a C₁-C₈-alkyl radical or C₆-C₁₄-aryl radical.

Other polymers suitable in principle are cycloolefin polymers which are obtained by ring-opening polymerization of at least one of the monomers of the formulae I to VI, followed by hydrogenation.

Cycloolefin homopolymers have a structure composed of monomers of the formulae I to VI. These cycloolefin polymers have lesser suitability for the purposes of the present invention. Suitable cycloolefin polymers (COC) for the purposes of the present invention are those which contain at least one cycloolefin of the formulae I to VI and also acyclic olefins of the formula VIII as comonomer. These cycloolefin copolymers which may be used according to the invention are termed COC hereinabove and hereinbelow. Preference is given here to acyclic olefins which have from 2 to 10 carbon atoms, in particular unbranched acyclic olefins having from 2 to 20 carbon atoms, for example ethylene, propylene, and/or butylene. The proportion of polymerized units of acyclic olefins of the formula VIII is up to 99% by weight, preferably from 5 to 80% by weight, particularly preferably from 10 to 60% by weight, based on the total weight of the respective COC.

Among the COCs described above, particular preference is given to those which contain polymerized units of polycyclic olefins having an underlying norbornene structure, particularly preferably norbornene or tetracyclododecene. Particular preference is also given to COCs which contain polymerized units of acyclic olefins, in particular ethylene. Particular preference is in turn given to norbornene-ethylene copolymers and tetracyclododecene-ethylene copolymers which contain from 5 to 80% by weight, preferably from 10 to 60% by weight (based on the weight of the copolymer).

The COCs generically described above generally have glass transition temperatures T_{g} of from −20 to 400° C. The invention can use COCs which have a glass transition temperature T_{g} greater than 70° C., preferably greater than 90° C., and in particular greater than 110° C. The viscosity number (decalin, 135° C., DIN 53 728) is advantageously from 0.1 to 200 ml/g, preferably from 50 to 150 ml/g.

The COCs are prepared by heterogeneous or homogeneous catalysis using organometallic compounds, and the preparation is described in numerous documents. DD 109 224, DD 237 070, and EP-A-0 156 464 describe suitable catalyst systems based on mixed catalysts composed of titanium compounds and, respectively, zirconium compounds or vanadium compounds combined with organylaluminum compounds. EP-A-0 283 164, EP-A-0 407 870, EP-A-0 485 893, and EP-A-0 503 422 describe the preparation of cycloolefin copolymers (COC) using catalysts based on soluble metallocene complexes. The processes described in the above-mentioned specifications for preparing cycloolefin copolymers are expressly incorporated herein by way of reference.

The form in which the COCs are incorporated into the films is either pure pellet form or pellet concentrate (masterbatch) form, the method being to premix the polyester pellets or polyester powder with the COC or with the COC masterbatch, and then feed the material to the extruder. In the extruder, the components undergo further mixing and are heated to the processing temperature. It is advantageous here for the process of the invention for the extrusion temperature to be above the glass transition temperature T_{g} of the COC, generally above the glass transition temperature T_{g} of the cycloolefin copolymer (COC) by at least 5 K, preferably by from 10 to 180 K, in particular by from 15 to 150 K.

The polymers used for the intermediate layers and, where appropriate, for the outer layer C may in principle be the same as those used for the base layer B described above. Besides these, this outer layer C and, where appropriate, the intermediate layers may also comprise other materials, and this outer layer C and, where appropriate, the intermediate layers are then preferably composed of a mixture of polymers, of a copolymer, or of a homopolymer, which contain ethylene 2,6-naphthalate units and ethylene terephthalate units.

The sealable outer layer A applied by coextrusion to the base layer B is based on polyester copolymers and is substantially composed of copolyesters whose composition is predominantly a mixture of isophthalic acid units and of terephthalic acid units, and of ethylene glycol units. The remaining monomer units derive from the other aliphatic, cycloaliphatic, or aromatic diols and, respectively, dicarboxylic acids which may also be present in the base layer B. The preferred copolyesters which provide the desired sealing properties are those composed of ethylene terephthalate units and ethylene isophthalate units and ethylene glycol units. The proportion of ethylene terephthalate is from 40 to 95 mol %, and the corresponding proportion of ethylene isophthalate is from 60 to 5 mol %. Preference is given to copolyesters in which the proportion of ethylene terephthalate is from 50 to 90 mol % and the corresponding proportion of ethylene isophthalate is from 50 to 10 mol %, and very particular preference is given to copolyesters in which the proportion of ethylene terephthalate is from 60 to 85 mol % and the corresponding proportion of ethylene isophthalate is from 40 to 15 mol %.

The total thickness of the film A vary within wide limits, and depends on the intended application. The preferred embodiments of the film of the invention have total thicknesses of from 4 to 500 μm, preferably from 8 to 300 μm, in particular from 10 to 300 μm. The thickness of any/each intermediate layer present is generally, independently of any other intermediate layer, from 0.5 to 15 μm, preferred intermediate layer thicknesses being from 1 to 10 μm, in particular from 1 to 8 μm. Each of the values given is based on one intermediate layer. The thickness of the outer layer(s) is selected independently of the other layers, and is preferably in the range from 0.1 to 10 μm, in particular from 0.2 to 5 μm, with preference from 0.3 to 2 μm, and outer layers applied on two sides here may have identical or different thickness and composition. The thickness of the base layer B is therefore the difference between the total thickness of the film and the thickness of the outer and intermediate layer(s) applied, and can, like the total thickness, therefore vary within wide limits.

For the skilled worker it is surprising that the white, sealable polyester film of the invention can be produced cost-effectively using, as stated above, a somewhat increased amount of DEG and/or PEG and/or IPA, and can then also be thermoformed without difficulty in commonly used thermoforming systems, provided a surprisingly high level of reproduction of detail in the process.

The base layer B and the other layers may also comprise conventional additives, such as stabilizers, antiblocking agents, and other fillers. They are advantageously added to the polymer or polymer mixture before melting begins.

Examples of stabilizers used are phosphorus compounds, such as phosphoric acid or phosphoric esters.

Typical antiblocking agents (also termed pigments in this context) are inorganic and/or organic particles, such as calcium carbonate, amorphous silica, SiO₂ in colloidal or chain-type form, talc, magnesium carbonate, barium carbonate, calcium sulfate, barium sulfate, lithium phosphate, calcium phosphate, magnesium phosphate, aluminum oxide, lithium fluoride, the calcium, barium, zinc, or manganese salts of the dicarboxylic acids used, carbon black, titanium dioxide, kaolin, and crosslinked polymer particles, e.g. polystyrene particles or acrylate particles.

The additives selected may also be a mixture of two or more different antiblocking agents or a mixture of antiblocking agents of the same composition but different particle size. The particles may be added to each of the layers of the film in the amounts advantageous in each case, e.g. in the form of a glycolic dispersion during polycondensation, or via masterbatches during extrusion. Pigment concentrations of from 0 to 25% by weight (based on the weight of the respective layer) have proven particularly suitable. A detailed description of the antiblocking agents is found by way of example in EP-A-0 602 964.

To improve the whiteness of the film, the base layer B or the other additional layers may comprise white pigmentation. It has proven particularly advantageous here for the additional additives selected to be barium sulfate at a particle size in the range from 0.3 to 0.8 μm, preferably from 0.4 to 0.7 μm, or titanium dioxide at a particle size of from 0.05 to 0.3 μm, in each case measured by the Sedigraph method. This gives the film a brilliant white appearance. The amount of barium sulfate is in the range from 1 to 25% by weight, preferably from 1 to 20% by weight, and very particularly preferably from 1 to 15% by weight.

The outer layers may in principle comprise the inventive additive concentrations given above. However, the following embodiments have proven particularly advantageous:

The lowest minimum sealing temperature and the highest seal seam strength are obtained when the copolymers described in more detail above are used for the sealable outer layer A. The best sealing properties are obtained for the film when no other additives at all, in particular no inorganic or organic particles, are added to the copolymers. In this case, using a given copolyester, the lowest minimum sealing temperature and the highest seal seam strengths are obtained. However, in this case the handling of the film is not ideal, since the surface of the sealable outer layer A tends to block.

It has therefore proven particularly advantageous to improve the handling of the film and the processability by modifying the sealable outer layer A with the aid of suitable antiblocking agents of a selected size, a certain amount of which is added to the sealing layer, and specifically in such a way as firstly to minimize blocking and secondly to leave no noticeable impairment of sealing properties. This desired combination of properties can be achieved if the topography of the sealable outer layer A is preferably characterized by the following set of parameters:
The roughness of the sealable outer layer, expressed in terms of Rₐ value, should be smaller than 100 nm and preferably ≦80 nm. Otherwise, there is an adverse effect on the sealing properties for the purposes of the present invention.
The value measured for surface gas flow time should preferably be in the range from 50 to 4 000 s. At values below 50 s, the sealing properties are adversely affected for the purposes of the present invention, and at values above 4 000 s the handling of the film becomes poor.

For processing performance it has proven particularly advantageous for the film also to have an outer layer C whose topography is preferably to be characterized by the following set of parameters:
The coefficient of friction (COF) of this side with respect to itself should preferably be smaller than 0.7 and particularly preferably ≦0.6. Otherwise the winding performance and the further processing of the film is less good.
The roughness of the non-sealable outer layer, expressed via the Rₐ value, should be ≧30 nm. Values smaller than 30 nm have adverse effects on the winding and processing performance of the film.
The value measured for surface gas flow time should advantageously be in the range below 500 S. Specifically, at values of 500 s or above the winding and processing performance of the film is adversely affected.

To achieve this particularly advantageous property profile of the film, it has an outer layer C which comprises a greater amount of pigment (i.e. a higher pigment concentration) than the outer layer A. The pigment concentration in this second outer layer C is from 0.1 to 10% by weight, advantageously from 0.12 to 8% by weight, and in particular from 0.15 to 6% by weight, based on the weight of this layer. In contrast, the other sealable outer layer opposite to the outer layer C has a lower level of filling by inert pigments. The concentration of the inert particles within layer A is advantageously from 0.01 to 0.3% by weight, preferably from 0.015 to 0.2% by weight, and in particular from 0.02 to 0.1% by weight, based on the weight of this layer.

The invention further relates to a process for producing the white, sealable polyester film of the invention by the extrusion or coextrusion process known per se.

For the purposes of this process, the procedure is that the individual melts corresponding to the individual layers of the film are coextruded through a flat-film die, the resultant film is drawn off for solidification on one or more rollers, the film is then biaxially stretched (oriented), and the biaxially stretched film is heat-set and, where appropriate, corona- or flame-treated on a surface intended for treatment, and is then wound up.

The biaxial stretching is generally carried out sequentially. For this, stretching is preferably first carried out longitudinally (i.e. in machine direction, =MD) and then transversely (i.e. perpendicularly to the machine direction, =TD). Where appropriate, another longitudinal stretching may follow the transverse stretching. The stretching leads to spatial orientation of the molecular chains of the polyester. The longitudinal stretching is preferably carried out with the aid of two or more rollers rotating at different angular velocities corresponding to the desired stretching ratio. For the transverse stretching use is generally made of an appropriate tenter frame.

The temperature at which the stretching is carried out may vary with relatively wide latitude and depends on the desired properties of the film. The longitudinal stretching is generally carried out at from 80 to 130° C. and the transverse stretching at from 90 to 150° C. The longitudinal stretching ratio is generally in the range from 2.5:1 to 6:1, preferably from 3:1 to 5.5:1. The transverse stretching ratio is generally in the range from 3.0:1 to 5.0:1, preferably from 3.5:1 to 4.5:1.

The stretching may also take place in a simultaneous stretching frame (simultaneous stretching), and the number of stretching steps and the sequence (longitudinal /transverse) is not of any decisive importance for the property profile of the film. However, advantageous stretching temperatures here are ≦125° C., ≦115° C. being particularly advantageous. The stretching ratios correspond to those in the conventional sequential process.

In the heat-setting which follows, the film is held for a period of from about 0.1 to 10 s at a temperature in the range from 150 to 250° C. The film is then wound up in the usual way.

To establish other desirable properties, the film may have been chemically treated or else corona- or flame-treated. The intensity of treatment is to be set so that the surface tension of the film is generally above 45 mN/m.

The film may likewise be coated in order to establish other properties. Typical coatings are layers with adhesion-promoting, antistatic, slip-improving, or release effect. Clearly, these additional layers may be applied to the film by the technique of in-line coating, by means of aqueous dispersions, after longitudinal stretching and prior to transverse stretching.

It was surprising that the film of the invention can be thermoformed to give complex moldings without any further pretreatment, in particular without any prior drying step.

Thermoforming very generally encompasses the steps of predrying, heating, molding, cooling, demolding, heat-conditioning, and cooling. In the thermoforming process it was found that the films of the invention can be molded to surprisingly good effect without the predrying step. This advantage over other thermoformable films made from polycarbonate or polymethyl methacrylate, which require, depending on the thickness of the film, pretreatments at temperatures of from 100 to 120° C. for periods in the range from 10 to 15 hours, drastically reduces costs for thermoforming when the film of the invention is used, thus making the thermoformable film of the invention particularly attractive in economic terms.

The following particularly suitable process parameters were found for thermoforming the white, sealable polyester film of the invention:

| | Film of the |
|---|---|
| Step | invention |
| Predrying | not required |
| Mold temperature [° C.] | 100 to 160 |
| Heating time | ≦5 sec per 10 μm of |
| | film thickness |
| Film temperature during | 160 to 200 |
| thermoforming [° C.] | |
| Possible thermoforming | 1.5 to 2.0 |
| factor | |
| Reproduction of detail | good |
| Shrinkage | ≦1.5% |

The particular advantage of the film of the invention is seen in high whiteness together with excellent sealability. The whiteness of the film is more than 70%, preferably more than 75%, and particularly preferably more than 80%. The opacity of the film of the invention is more than 55%, preferably more than 60%, and particularly preferably more than 65%.

However, particular emphasis should be given to the economically significant and particularly surprising advantage that cut material arising directly during production of the film can be reused for film production as regrind in amounts in the range from 10 to 70% by weight, based on the total weight of the film, without any significant resultant adverse effect on the physical properties of the resultant film. In particular, the regrind (substantially composed of polyester and COC) does not cause any undefined change in the color of the film, which is always the case with films of the prior art.

The good handling of the film and its very good processing properties make it particularly suitable for processing on high-speed machinery.

The film of the invention has excellent suitability for producing thermoformed packaging for foods or other consumables which are sensitive to light and/or to air. It also has excellent suitability for use in industry, e.g. in the production of stamping foils, or as a label film. Besides this, the film is naturally particularly suitable for the production of thermoformed moldings of any type, or for image-recording papers, printed sheets, magnetic recording cards, to mention just a few possible applications.

The excellent combination of properties of the film also make it suitable for a wide variety of different applications, for example for interior decoration, for the construction of exhibition stands or for exhibition requisites, as a display, for placards, for protective glazing on machinery or on vehicles, in the lighting sector, in the fitting out of shops or of stores, or as a promotional item or laminating medium.

The table below (Table 1) gives once again the most important film properties of the invention at a glance.

TABLE 1
Properties; inventive range

| | | | | |
|---|---|---|---|---|
| | | Particularly | | |
| Inventive range | Preferred | preferred | Unit | Test method |

Outer layer A

| | | | | | |
|---|---|---|---|---|---|
| Minimum sealing | <200 | <180 | <160 | ° C | internal |
| temp. | | | | | |
| Seal seam strength | >0.8 | >1 | >1.2 | N/15 mm | internal |
| Average roughness Rₐ | <100 | <80 | <60 | nm | DIN 4768, cut-off at 0.25 mm |
| Value measured for | 50 to 4000 | 200-3500 | 500-3000 | sec | internal |
| surf. gas flow time | | | | | |
| Gloss, 60° | >50 | >70 | >90 | | DIN 67 530 |

Outer layer C or base layer B if external layer

| | | | | | |
|---|---|---|---|---|---|
| COF | <0.7 | <0.6 | <0.40 | | DIN 53 375 |
| Average roughness Rₐ | >30 | >45 | >50 | nm | DIN 4768, cut-off at 0.25 mm |
| Value measured for | <500 | <400 | <300 | sec | internal |
| surf. gas flow time | | | | | |
| Gloss, 60° | >50 | >70 | >90 | | |

Other film properties

| | | | | | |
|---|---|---|---|---|---|
| Whiteness | >70 | >75 | >80 | % | Berger |
| Opacity | >55 | >60 | >65 | % | DIN 53 146 |

For the purposes of the present invention, the following test methods were utilized to characterize the raw materials and the polymers:

DEG/PEG/IPA Content

The amount of DEG, PEG and/or IPA in the polyester is determined by gas chromatography after saponification in methanolic KOH followed by neutralization with aqueous hydrochloric acid.

SV (Standard Viscosity)

Standard viscosity SV (DCA) is measured by a method based on DIN 53726, in dichloroacetic acid.

Intrinsic viscosity (IV) is calculated as follows from standard viscosity
IV(DCA)=6.67·10⁻⁴SV(DCA)+0.118
Coefficient of Friction (COF)

Coefficient of friction was determined to DIN 53 375. The coefficient of sliding friction was measured 14 days after production.

Surface Tension

Surface tension was determined by what is known as the ink method (DIN 53 364).

Roughness

The roughness Rₐ of the film was determined to DIN 4768 with a cut-off of 0.25 mm.

Whiteness and Opacity

Whiteness and opacity are determined with the aid of the “ELREPHO” electrical reflectance photometer from Zeiss, Oberkochem (Germany), standard illuminant C, 2° normal observer. Opacity is determined to DIN 53 146. Whiteness is defined as W═RY+3RZ−3RX.

W=whiteness, and RY, RZ, and RX=relevant reflection factors when the Y, Z and X color-measurement filter is used. The white standard used was a barium sulfate pressing (DIN 5033, Part 9). A detailed description is given by way of example in Hansl Loos “Farbmessung” [“Color Measurement”], Verlag Beruf und Schule, Itzehoe (1989).

Light Transmittance

Measurement of light transmittance is based on ASTM-D 1033-77.

Gloss

Gloss was determined to DIN 67 530 at a measuring angle of 60′. Reflectance was measured, this being an optical value characteristic of a film surface. A beam of light hits the flat test surface at the set angle of incidence and is reflected and/or scattered thereby. A proportional electrical variable is displayed representing light rays hitting the photoelectronic detector. The value measured is dimensionless and must be stated together with the angle of incidence.

Glass Transition Temperature T_{g}

The glass transition temperature was determined using film specimens with the aid of DSC (differential scanning calorimetry) (DIN 73 765). A DuPont DSC 1090 was used. The heating rate was 20 K/min and the specimen weight was about 12 mg. The glass transition T_{g} was determined in the first heating procedure. Many of the specimens showed an enthalpy relaxation (a peak) at the beginning of the step-like glass transition. The temperature taken as T_{g} was that at which the step-like change in heat capacity—without reference to the peak-shaped enthalpy relaxation—achieved half of its height in the first heating procedure. In all cases, there was only a single glass transition observed in the thermogram in the first heating procedure.

Minimum Sealing Temperature

Hot-sealed specimens (seal seam 20 mm×100 mm) are produced with a Brugger HSG/ET sealing apparatus, by sealing the film at different temperatures with the aid of two heated sealing jaws at a sealing pressure of 2 bar and with a sealing time of 0.5 s. From the sealed specimen test strips of 15 mm width were cut. The T-seal seam strength was measured as in the determination of seal seam strength. The minimum sealing temperature is the temperature at which a seal seam strength of at least 0.5 N/15 mm is achieved.

Seal Stream Strength

To determine the seal seam strength, two film strips of width 15 mm were placed one on top of the other and sealed at 130° C. with a sealing time of 0.5 s and a sealing pressure of 2 bar (apparatus: Brugger NDS, single-side-heated sealing jaw). The seal seam strength was determined by the T-peel method.

Surface Gas Flow Time

The principle of the test method is based on the air flow between one side of a film and a smooth silicon wafer sheet. The air flows from the surroundings into an evacuated space, and the interface between film and silicon wafer sheet acts as a flow resistance.

A round specimen of film is placed on a silicon wafer sheet, in the middle of which there is a hole providing the connection to the receiver. The receiver is evacuated to a pressure below 0.1 mbar. The time in seconds taken by the air to establish a pressure rise of 56 mbar in the receiver is determined.

Test Conditions:

| | | |
|---|---|---|
| Test area | 45.1 | cm² |
| Weight applied | 1276 | g |
| Air temperature | 23° | C. |
| Humidity | 50% | relative humidity |
| Aggregated gas volume | 1.2 | cm³ |
| Pressure difference | 56 | mbar |

### EXAMPLE 1

Coextrusion technology was used to produce a multilayer film of thickness 23 μm with layer sequence A-B, B being the base layer and A being the outer layer. The thickness of the base layer B was 21.5 μm and that of the other layer A was 1.5 μm.

Chips of polyethylene terephthalate which comprised an amount of 1.25% by weight of DEG (prepared via the transesterification process using Mn as transesterification catalyst, Mn concentration: 100 ppm) were dried at 150° C. to a residual moisture below 100 ppm and fed to the extruder for the base layer B. Alongside this, chips of cycloolefin copolymer (COC) from Ticona: ®Topas 6015 (COC composed of 2-norbornene and ethylene, see also W. Hatke: Folien aus COC [COC films], Kunststoffe 87 (1997) 1, pp. 58-62) with a glass transition temperature T_{g} of 160° C. were likewise fed to the extruder for the base layer B. The quantitative proportion of COC in the base layer B was 10% by weight.

97% by weight of chips of a linear polyester were fed to the outer layer A, which was composed of an amorphous copolyester having 78 mol % of ethylene terephthalate and 22 mol % of ethylene isophthalate (prepared via the transesterification process using Mn as transesterification catalyst, Mn concentration: 100 ppm). The copolyester was dried at a temperature of 100° C. to residual moisture below 200 ppm and fed to the extruder for sealable outer layer A. The extruder was also fed with 3% by weight of chips of a masterbatch which alongside the polyester with a quantitative proportion of 1.25% by weight of DEG also comprises 10 000 ppm of silicon dioxide®Sylobloc, Grace, Germany) and 12 500 ppm of silicon dioxide®Aerosil, fumed SiO₂ from Degussa) These chips, too, were dried at 100° C. to residual moisture below 200 ppm.

Coextrusion followed by stepwise longitudinal and transverse orientation was used to produce a white, opaque two-layer film with a total thickness of 23 μm.

The base layer B is a mixture of:

| | |
|---|---|
| 90.0% by weight | of polyethylene terephthalate homo- |
| | polymer having 1.25% by weight of DEG |
| | (RT49, Kosa, Germany) |
| 10.0% by weight | of cycloolefin copolymer (COC) from |
| | Ticona, ®Topas 6015 |

The production conditions in each of the steps of the process were:

| | | | |
|---|---|---|---|
| Extrusion: | Temperatures for base layer and | 280° | C. |
| | outer layer: | | |
| | Temperature of take-off roller: | 30° | C. |
| Longitudinal | Temperature: | 80-125° | C. |
| stretching: | Longitudinal stretching ratio: | 4.2 | |
| Transverse | Temperature: | 80-135° | C. |
| stretching: | Longitudinal stretching ratio: | 4.0 | |
| Setting: | Temperature: | 230° | C. |
| | Duration: | 3 | s |

These process parameters apply to all of the examples (other than comparative examples).

The film had the required good properties and exhibited the desired handling and the desired processing performance. The properties achieved in films produced in this way are shown in Tables 2 and 3.

### EXAMPLE 2

The difference from Example 1 was that now 50% by weight of regrind was added to the base layer B. The amount of COC in the base layer B thus produced was again 10% by weight. No changes were made to the process parameters of Example 1. The outer layer A remained unchanged. The yellowing of the film was observed visually. Tables 2 and 3 show that hardly any yellowing of the film was visible.

Base layer B is a mixture of:
44.7% by weight of polyethylene terephthalate homo-polymer having 1.25% by weight of DEG and having an SV value of 800
50.0% by weight of regrind (polymer content: 90.7% by weight of polyester including isophthalate+9.3% by weight of Topas 6015)
5.3% by weight of cycloolefin copolymer (COC) from Ticona, ®Topas 6015

### EXAMPLE 3

The structure of the base layer B was as in Example 1, but its thickness was only 40.5 μm. The sealable outer layer A had a thickness of 2.5 μm. A third pigmented outer layer C of thickness 2.0 μm was also coextruded concomitantly (drying as outer layer A).

This outer layer C comprised:
88% by weight of polyethylene terephthalate homo-polymer having 1.25% by weight of DEG and having an SV value of 800
12% by weight of masterbatch made from polyester having 1.25% by weight of DEG and having 10 000 ppm of silicon dioxide (®Sylobloc, Grace, Germany) and 12 500 ppm of silicon dioxide (®Aerosil, fumed SiO₂ from Degussa)

The other process conditions were as in Example 1.

The good whiteness and sealability properties of the film were the same as those of the film from Examples 1 and 2, but it exhibited a further improvement in processing performance. The properties achieved in films produced in this way are shown in Tables 2 and 3.

### EXAMPLE 4

The procedure was as in Example 3, but 50% by weight of regrind of the material used were added to the base layer B. The amount of COC in the base layer B was again 10% by weight. The process parameters of Example 1 were not changed. Yellowing of the film was observed visually.

Tables 2 and 3 show hardly any yellowing of the film was visible.

### COMPARATIVE EXAMPLE 1

A film was produced having a structure as in Example 3. However, the polyester used for all of the layers A, B, and C had only a quantitative proportion of 0.45% by weight of DEG. The properties of the film are described in Tables 2 and 3. This film lacked adequate thermoformability.

### COMPARATIVE EXAMPLE 2

Example 1 from EP-A-0 300 060 was repeated. The example was modified by providing the film with a sealable outer layer A which had a thickness of 2.0 μm, and 50% by weight of regrind was also processed concomitantly for the base layer. It is seen from Table 2 that marked yellowing of the film was visible.

Base layer B is a mixture of:
45.0% by weight of polyethylene terephthalate homo-polymer having 0.6& by weight of DEG and having an SV of 800

50.0% by weight of regrind from identical material (95% by weight of polyester+5% by weight of polypropylene) 5.0% by weight of polypropylene.

TABLE 2

| | Film | | Layer thicknesses | | | | | | Average particle | | | Pigment concentrations | | |
|---|---|---|---|---|---|---|---|---|---|---|---|---|---|---|
| | thickness | Film | μm | | | Particles in layers | | | diameter in layers μm | | | ppm | | |
| Example | μm | structure | A | B | C | A | B | C | A | B | C | A | B | C |
| E 1 | 23 | AB | 1.5 | 21.5 | — | Sylobloc 44 H | none | | 2.5 | | | 300 | 0 | |
| | | | | | | Aerosil TT 600 | | | 0.04 | | | 375 | | |
| E 2 | 23 | AB | 1.5 | 21.5 | — | Sylobloc 44 H | some | | 2.5 | | 2.5 | 300 | <100 ppm | 1200 |
| | | | | | | Aerosil TT 600 | via | | 0.04 | | 0.04 | 375 | | 1500 |
| | | | | | | | regrind | | | | | | | |
| E 3 | 40.5 | ABC | 2.5 | 36 | 2.0 | Sylobloc 44 H | none | Sylobloc 44 H | 2.5 | | 2.5 | 300 | 0 | 1200 |
| | | | | | | Aerosil TT 600 | | Aerosil TT 600 | 0.04 | | 0.04 | 375 | | 1500 |
| E 4 | 40.5 | ABC | 2.5 | 36 | 2.0 | Sylobloc 44 H | some | Sylobloc 44 H | 2.5 | | 2.5 | 300 | <100 ppm | 1200 |
| | | | | | | Aerosil TT 600 | via | Aerosil TT 600 | 0.04 | | 0.04 | 375 | | 1500 |
| | | | | | | | regrind | | | | | | | |

TABLE 3

| | | | | Concen- | | | | | | Seal seam | | | |
|---|---|---|---|---|---|---|---|---|---|---|---|---|---|
| | | | | tration | | | | | Minimum | strength | | Average | |
| | | | | of | Glass | | | | sealing | (side A | | rough- | |
| | Film | | Additive | additive | transition | | | Assess- | temperature | with | | ness Rₐ | |
| | thick- | | to | in base | temperature | White- | | ment of | (side A with | respect to | Thermo- | nm | |
| Ex- | ness | Layer | polyester | layer | of additive | ness | Opacity | film | respect to | A) | form- | Side | Side |
| ample | μm | structure | % | % | ° C. | % | % | yellowness | A) ° C. | N/15 mm | ability | A | B |
| E 1 | 23 | AB | COC | 10 | 170 | 75 | 72 | ++ | 101 | 1.9 | Good | 25 | 118 |
| E 2 | 23 | AB | COC | 10 | 170 | 74 | 74 | + | 99 | 2.1 | Good | 27 | 120 |
| E 3 | 40.5 | ABC | COC | 10 | 170 | 71 | 71 | ++ | 97 | 2.0 | Good | 26 | 64 |
| E 4 | 40.5 | ABC | COC | 10 | 170 | 72 | 70 | + | 99 | 2.1 | Good | 28 | 66 |
| CE 1 | 40.5 | ABC | COC | 10 | 170 | 82 | 80 | 0 | 98 | 3.1 | Poor | 25 | 66 |
| CE 2 | 100 | AB | PP | 10 | −10 | 88 | 80 | − | 98 | 2.8 | Poor | 27 | 182 |

Key to yellowness of film produced:
++: no yellowness discernible
+: slight yellowness discernible
−: marked yellowness discernible

1. A white, sealable, biaxially oriented, thermoformable and coextruded polyester film encompassing at least one base layer B and at least one sealable outer layer A, both comprising thermoformable thermoplastic polyester, wherein at least the base layer B also comprises, besides polyester, an amount in the range from about 2 to about 60% by weight of a cycloolefin copolymer (COC), based on the weight of the base layer B, wherein the glass transition temperature T_{g} of the cycloolefin copolymer (COC) is in the range from about 70 to about 270° C., and said sealable outer layer A further comprises sealable thermoplastic polyester,
and wherein the thermoformable polyester for the base layer B and for the outer layer A contains one or more of
a) an amount of >0.5% by weight, of diethylene glycol,
b) an amount of >0.5% by weight, of polyethylene glycol, and
c) an amount in the range from about 3 to about 10% by weight of isophthalic acid, and the roughness of the sealable outer layer A, expressed via its Rₐ value, is less than or equal to 100 nm.

2. The white, sealable polyester film as claimed in claim 1, wherein the cycloolefin copolymer (COC) comprises polynorbornene, polydimethyloctahydro-naphthalene, polycyclopentene, or poly(5-methyl)-norbornene, and has a glass transition temperature T_{g} in the range from about 90 to about 250° C.

3. The white, sealable polyester film as claimed in claim 1, wherein the COC has a glass transition temperature T_{g} in the range from about 110 to about 220° C.

4. The white, sealable polyester film as claimed in claim 1, which has a whiteness of more than about 70% and an opacity of more than about 55%.

5. The white, sealable polyester film as claimed in claim 1, wherein the sealable thermoplastic polyester of outer layer A comprises a polyester copolymer which contains an amount in the range from about 40 to about 95 mol % of ethylene terephthalate units and contains an amount in the range from about 60 to about 5 mol % of ethylene isophthalate units, based on the total amount of carboxylic acid units, and wherein the monomer units derive from aliphatic, cycloaliphatic or aromatic diols.

6. The white, sealable polyester film as claimed in claim 1, wherein the sealable outer layer A has a thickness in the range from about 0.2 to about 5.0 μm, and has a minimum sealing temperature of ≦200° C.

7. The white, sealable polyester film as claimed in claim 1, which has a total thickness in the range from about 4 to about 500 μm.

8. A white, sealable, biaxially oriented, thermoformable and coextruded polyester film encompassing at least one base layer B and at least one sealable outer layer A, both comprising thermoformable thermoplastic polyester, wherein at least the base layer B also comprises, besides polyester, an amount in the range from about 2 to about 60% by weight of a cycloolefin copolymer (COC), based on the weight of the base layer B, wherein the glass transition temperature T_{g} of the cycloolefin copolymer (COC) is in the range from about 70 to about 270° C., and wherein the sealable outer layer A further comprises sealable polyester and the roughness of the sealable outer layer A, expressed via its Rₐ value, is less than or equal to 100 nm, and that its value measured for surface gas flow time is in the range from about 50 to about 4 000 s
The thermoformable polyester for the base layer B and for the outer layer A containing one or more of
a) an amount of >0.5% by weight of diethylene glycol,
b) an amount of >0.5% by weight of polyethylene glycol, and
c) an amount in the range from about 3 to about 10% by weight of isophthalic acid.

9. The white, sealable polyester film as claimed in claim 1, wherein an intermediate layer has been arranged between the COC-containing base layer B and the sealable outer layer A.

10. A white, sealable, biaxially oriented, thermoformable and coextruded polyester film encompassing at least one base layer B, a sealable outer layer A and an outer layer C, each comprising thermoformable thermoplastic polyester and said layer A further comprising sealable thermoplastic polyester, wherein at least the base layer B also comprises, besides polyester, an amount in the range from about 2 to about 60% by weight of a cycloolefin copolymer (COC), based on the weight of the base layer B, wherein the glass transition temperature T_{g} of the cycloolefin copolymer (COC) is in the range from about 70 to about 270° C., said outer layer C exhibiting (i) a coefficient of friction (COF) with respect to itself of smaller than about 0.7, (ii) a roughness, expressed via its Rₐ value, of >30 nm, and (iii) a value measured for surface gas flow time in the range below about 500 s,
the thermoformable polyester for the base layer B and for the outer layers A and C containing one or more of
a) an amount of >0.5% by weight of diethylene glycol,
b) an amount of >0.5% by weight of polyethylene glycol, and
c) an amount in the range from about 3 to about 10% by weight of isophthalic acid.

11. The white, sealable polyester film as claimed in claim 10, wherein the outer layer C comprises an amount of pigments in the range from about 0.1 to about 10% by weight.

12. A process for producing a polyester film as claimed in claim 1, which comprises compressing and plasticizing, in separate extruders, a polymer or a polymer mixture for each of the layers to produce polymer melts, then simultaneously pressing the melts through a flat-film die (slot die) to produce an extruded multilayer film, drawing off the extruded multilayer film on one or more take-off rollers to produce a prefilm, then biaxially stretching and heat-setting the resultant prefilm.

13. The process as claimed in claim 12, wherein cut material arising directly during production of the film is reused for film production in the form of regrind in an amount in the range from about 10 to about 70% by weight, based on the total weight of the film.

14. A method of making a thermoformed packaging for foods or other consumable items which are sensitive to light and/or to air which method comprises converting a white, sealable film as claimed in claim 1 into a thermoformed packaging.

15. A method of making a stamping foil which method comprises converting a white, sealable film as claimed in claim 1 into a stamping foil.

16. A method of making a label film which method comprises converting a white, sealable film as claimed in claim 1 into a label film.

17. A method of making a thermoformed molding which method comprises converting a white, sealable film as claimed in claim 1 into a thermoformed molding.

18. A method of making an image-recording paper which method comprises converting a white, sealable film as claimed in claim 1 into an image-recording paper.

19. A method of making a printed sheet which method comprises converting a white, sealable film as claimed in claim 1 into a printed sheet.

20. A method of making a magnetic recording card which method comprises converting a white, sealable film as claimed in claim 1 into a magnetic recording card.

21. A method of making an interior decoration which method comprises converting a white, sealable film as claimed in claim 1 into an interior decoration.

22. A method of making a display, for placards which method comprises converting a white, sealable film as claimed in claim 1 into a display, for placards.

23. A method of making a promotional item which method comprises converting a white, sealable film as claimed in claim 1 into a promotional item.

24. A method of making a laminating medium which method comprises converting a white, sealable film as claimed in claim 1 into a laminating medium.

25. A method of making a protective cover which method comprises converting a white, sealable film as claimed in claim 1 into a protective cover.

26. A white, sealable, biaxially oriented, thermoformable and coextruded polyester film according to claim 1, said film further comprising recycle formed from said film in an amount ranging from about 10 to about 70% by weight, based on the total weight of the film.

27. A white, sealable, biaxially oriented, thermoformable film according to claim 1, said thermoformable polyester comprising one or more of
a) an amount of >1.0% by weight of diethylene glycol,
b) an amount of >1.0% by weight of polyethylene glycol, and
c) an amount in the range from about 3 to about 10% by weight of isophthalic acid.

28. A white, sealable, biaxially oriented, thermoformable film according to claim 1, wherein the thermoformable thermoplastic polyester is derived from at least one of polyethylene terephthalate, polyethylene 2,6-naphthalate, poly-1,4-cyclohexanedimethylene terephthalate or polyethylene 2,6-naphthalate bibenzoate.
